(19) United States
(12) Patent Application Publication
(10) Pub. No.: US 2024/0277570 A1
(43) Pub. Date: Aug. 22, 2024

(54) PILL CONTAINER AND METHODS OF MAKING AND USING SAME

(71) Applicant: Donald J. Brobst, JR., Drums, PA (US)

(72) Inventor: Donald J. Brobst, JR., Drums, PA (US)

(21) Appl. No.: 18/111,938

(22) Filed: Feb. 21, 2023

(51) Int. Cl. A61J 1/03; A61J 7/00

(52) U.S. Cl. CPC A61J 1/03; A61J 7/0007

(57) ABSTRACT

A pill container, including a base assembly, wherein the base assembly having a base, a plurality of slots located on one edge of the base, a plurality of pill wells located around a periphery of the base, wherein each of the pill wells is sized and shaped to retain a pill, a base divider located adjacent to the plurality of pit wells, and a bottom located adjacent to the plurality of the pit wells and the base divider, and a lid assembly, wherein the lid assembly includes a lid, a plurality of lid extensions operatively connected to a first edge of the lid, wherein each of the plurality of lid extensions is rotatably retained within one of the plurality of slots, a latch operatively connected to a second edge of the lid, and a compartment extension operatively connected to a third and fourth edge of the lid.

### FIELD OF THE INVENTION

The present invention is generally related to pill containers and methods of making and using the same. The pill container includes a base having a plurality of wells for containing pills, capsules, tablets, supplements, or other similar medications. The base also includes a compartment for containing other smokable or vapable items such as tobacco products (i.e., mini-cigarettes or cigars) and/or marijuana products. The lid can be hingedly connected to the base. The lid also includes a plurality of pill break ridges to assist in breaking hard pills, capsules, tablets, supplements, or other similar medications. Finally, the lid includes a finger grip that can be used to assist in opening the lid away from the base and in providing a cover over the compartment on the base so that the other small items located within the compartment do not come out of the compartment while the pill container is being transported.

### BACKGROUND OF THE INVENTION

Prior to the present invention, as set forth in general terms above and more specifically below, it is known, to employ various types of containers that are used for holding pills. In particular, these containers utilize a compartment for holding the pill or pills and a lid that is connected to the compartment in order to assist in retaining the pill or pills within the compartment.

However, it would be desired to provide a container that is capable of holding a variety of different types of pills, capsules, tablets, supplements, or other similar medications. Secondly, it would be desired to provide a container that is also capable of providing a compartment for containing other smokable or vapable items such as tobacco products (i.e., mini-cigarettes or cigars) and/or marijuana products. Thirdly, it would desired to provide a container wherein the lid includes a plurality of pill break ridges to assist in breaking hard pills, capsules, tablets, supplements, or other similar medications. Finally, it would be desired to provide a container wherein the lid includes a finger grip that can be used to assist in opening the lid away from the base and provides a cover over the compartment on the base so that the other small items located within the compartment do not come out of the compartment while the pill container is being transported.

It is a purpose of this invention to fulfill these and other needs in the art of pill containers in a manner more apparent to the skilled artisan once given the following disclosure.

The preferred pill container, according to various embodiments of the present invention, offers the following advantages: ease of use; lightness in weight; durability; portability; the ability to hold a plurality of different types of pills, capsules, tablets, supplements, or other similar medications; the ability to retain other smokable or vapable items such as tobacco products like mini-cigarettes or cigars and/or marijuana products; the ability to properly retain the different types of pills, capsules, tablets, supplements, or other similar medications within the base; the ability to break hard pills, capsules, tablets, supplements, or other similar medications; and ease of opening the container. In fact, in many of the preferred embodiments, these advantages are optimized to an extent that is considerably higher than heretofore achieved in prior, known pill containers.

### BRIEF DESCRIPTION OF THE DRAWINGS

The above-mentioned features and steps of the invention and the manner of attaining them will become apparent, and the invention itself will be best understood by reference to the following description of the embodiments of the invention in conjunction with the accompanying drawings, wherein like characters represent like parts throughout the several views and in which:

FIG. 1 is a top, isometric view of a container base for use with a pill container, according to one embodiment of the present invention;

FIG. 2 is another top, isometric view of the container base for use with the pill container, according to one embodiment of the present invention;

FIG. 3 is a bottom, isometric view of the container base for use with the pill container, according to one embodiment of the present invention;

FIG. 4 is a top, isometric view of a container lid for use with the pill container, according to one embodiment of the present invention;

FIG. 5 is a top view of the container lid for use with the pill container, according to one embodiment of the present invention;

FIG. 6 is a side view of the container lid for use with the pill container, taken along lines 6-6 in FIG. 5, according to one embodiment of the present invention;

FIG. 7 is a top, isometric view of the pill container with the lid open, according to an embodiment of the present invention;

FIG. 8 is another top, isometric view of the pill container with the lid open, according to an embodiment of the present invention;

FIG. 9 is a top view of the pill container with the lid open, constructed according to an embodiment of the present invention;

FIG. 10 is a side view of the pill container with the lid open, taken along lines 10-10 in FIG. 9, constructed according to an embodiment of the present invention;

FIG. 11 is a front view of the pill container with the lid open, constructed according to an embodiment of the present invention;

FIG. 12 is a side view of the pill container with the lid open, taken along lines 12-12 in FIG. 11, constructed according to an embodiment of the present invention;

FIG. 13 is a bottom, isometric view of the pill container with the lid open, constructed according to an embodiment of the present invention;

FIG. 14 is a bottom view of the pill container with the lid open, constructed according to an embodiment of the present invention;

FIG. 15 is a top view of the pill container with the lid closed, constructed according to an embodiment of the present invention;

FIG. 16 is a top, isometric view of the pill container with the lid closed, constructed according to an embodiment of the present invention;

FIG. 17 is another top, isometric view of the pill container with the lid closed, constructed according to an embodiment of the present invention;

FIG. 18 is a bottom, isometric view of the pill container with the lid closed, constructed according to an embodiment of the present invention;

FIG. 19 is a side view of the pill container with the lid closed, taken along lines 19-19 in FIG. 15, constructed according to an embodiment of the present invention; and

FIG. 20 is a side view of the pill container with the lid closed, taken along lines 20-20 in FIG. 15, constructed according to an embodiment of the present invention.

### DETAILED DESCRIPTION OF THE PREFERRED EMBODIMENTS OF THE INVENTION

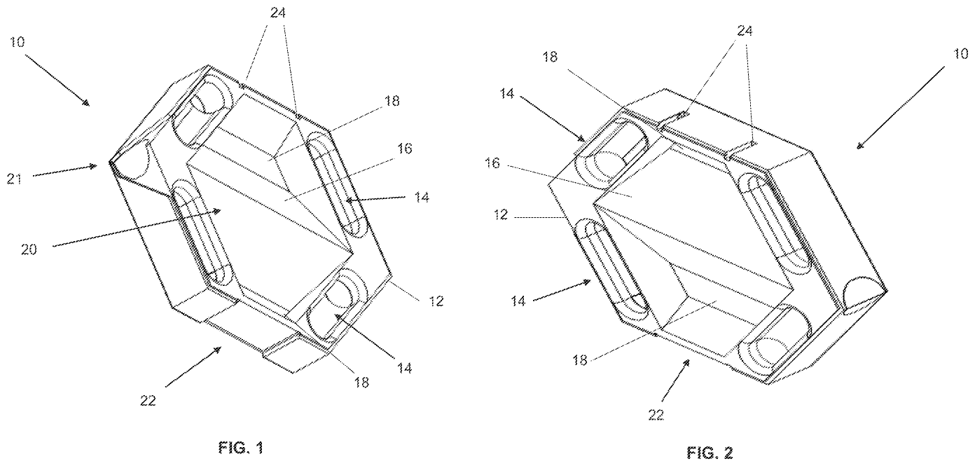

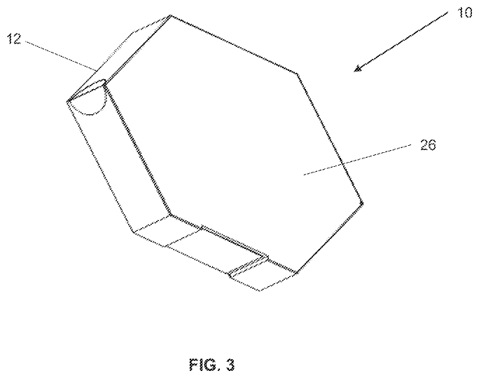

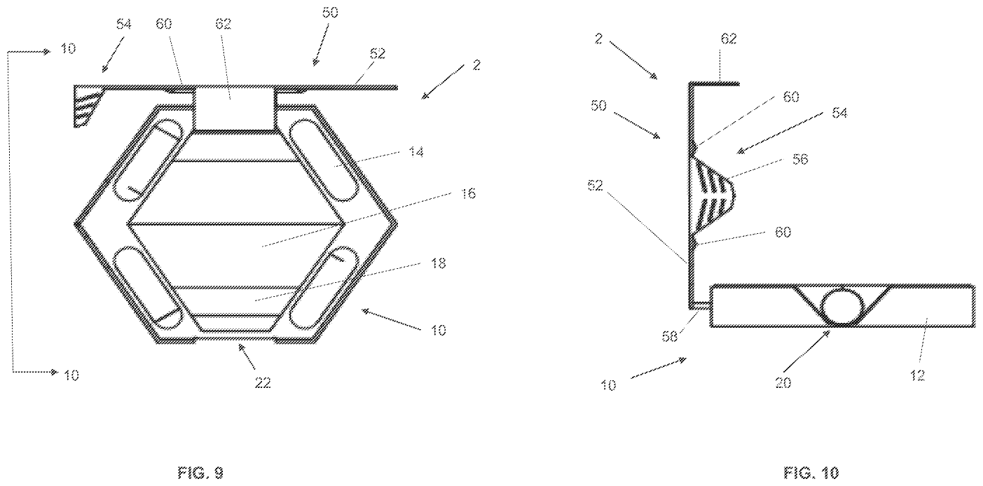

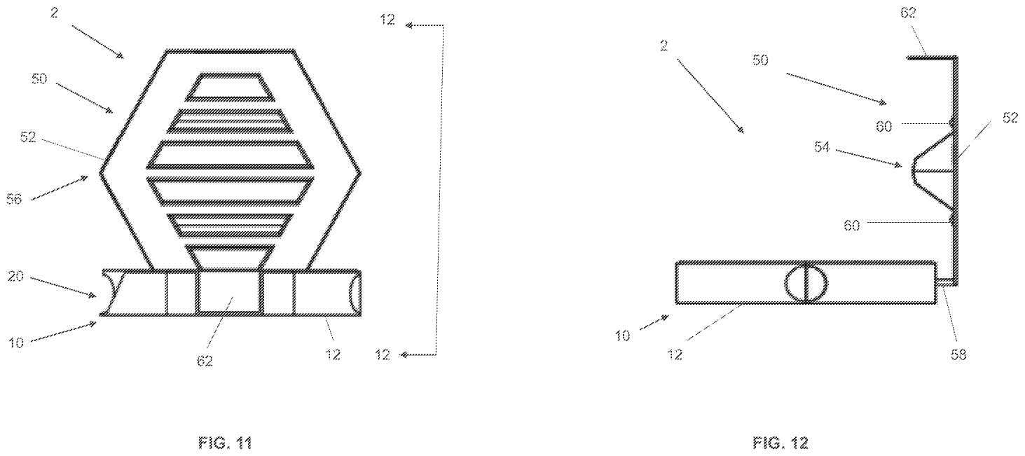

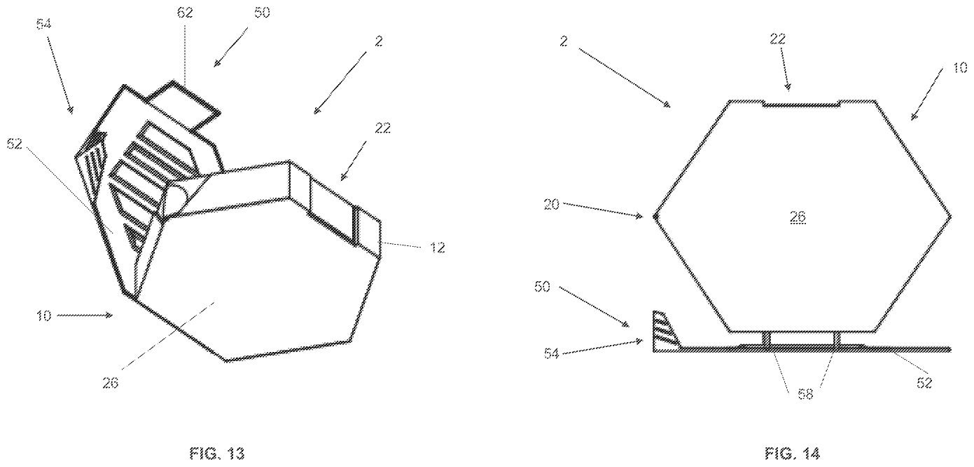

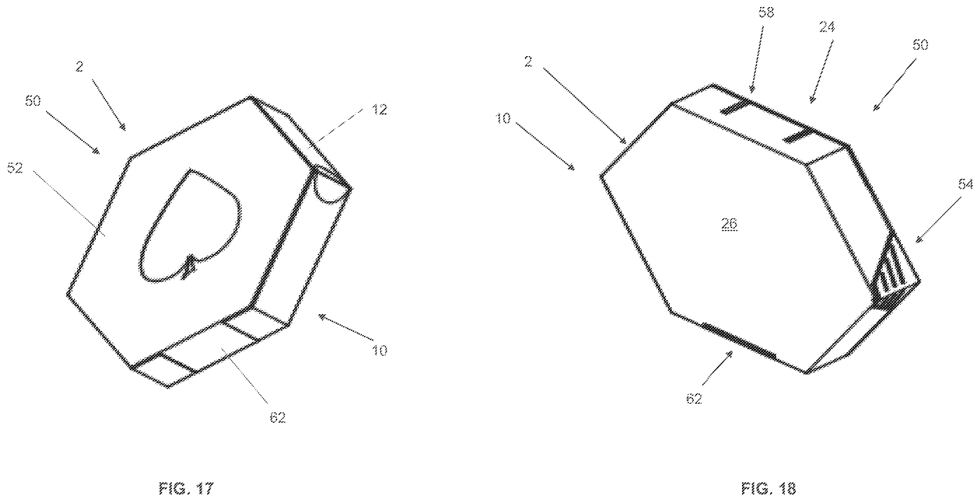

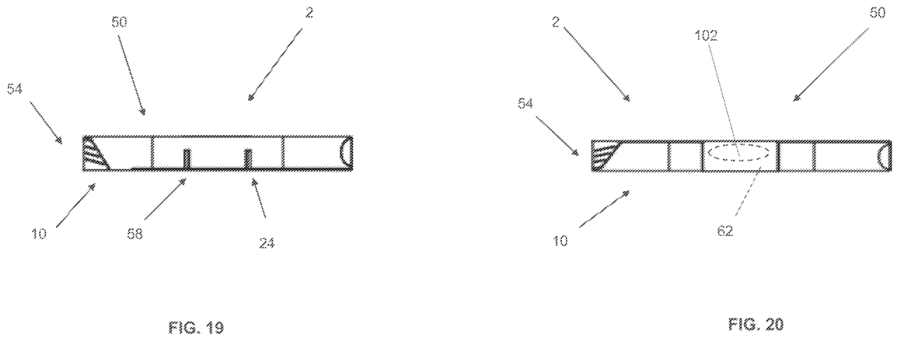

Referring now to FIGS. 1-20, there is illustrated a pill container 2 and methods of making and using the same. The pill container 2 includes a base assembly 10 having a plurality of wells for containing pills, capsules, tablets, supplements, or other similar medications. The base assembly 10 also includes a compartment for containing other smokable or vapable items such as tobacco products (i.e., mini-cigarettes or cigars) and/or marijuana products. The lid assembly 50 can be hingedly connected to the base assembly 10. The lid assembly 50 also includes a plurality of pill break ridges to assist in breaking hard pills, capsules, tablets, supplements, or other similar medications. Finally, the lid assembly 50 includes a finger grip that can be used to assist in opening the lid away from the base assembly 10 and in providing a cover over the compartment on the base assembly 10 so that the other small items located within the compartment do not come out of the compartment while the pill container 2 is being transported.

### Base Assembly and Lid Assembly

As shown in FIGS. 1-6, pill container 2 includes, in part, base assembly 10 and lid assembly 50. It is to be understood that pill container 2 can be constructed of any suitable, durable, high strength polymeric or metallic material. It is to be understood that pill container 2 can be constructed by such conventional techniques as printing, forming, molding, pressing, grinding, or the like.

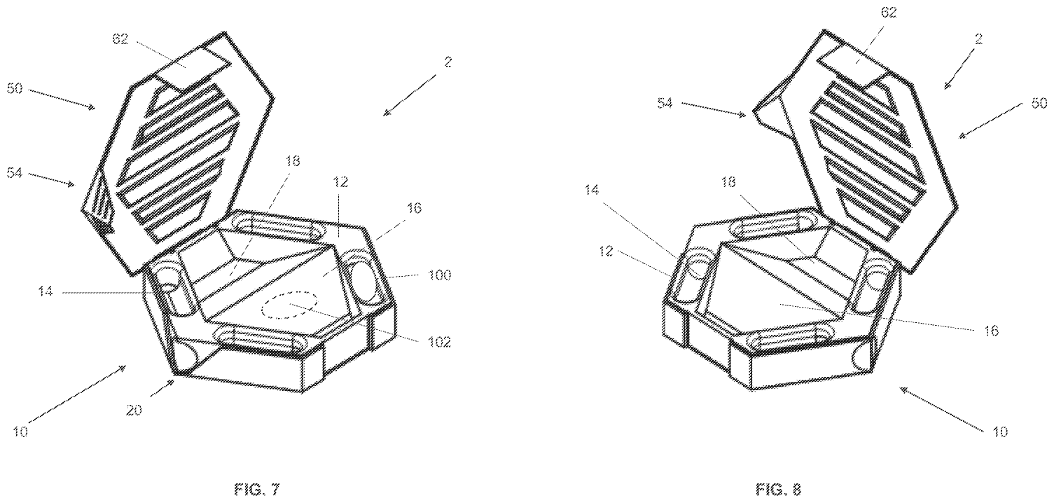

With respect to base assembly 10, as shown in FIGS. 1-3, base assembly 10 includes in part, base 12, pill wells 14, base divider 16, pill compartments 18, compartment 20, opening 21, base inset 22, and slots 24. In one embodiment, base inset 22 and slots 24 are formed into base 12 by conventional forming techniques such as printing, grinding, molding or the like. In another embodiment, each pill well 14 is sized and shaped so as to be able to retain a pill 100 (FIG. 7). However, it is to be understood that pill wells 14 can also be used to contain capsules, tablets, supplements, or other similar medications.

A unique aspect of the present invention is base divider 16. In one embodiment, base divider 16 can be used to separate pill compartments 18. In another embodiment, base divider 16 can be used to create compartment 20, as will be described in greater detail later.

Another unique aspect of the present invention is compartment 20. In one embodiment, one end of base 12 includes an opening 21. The opening 21 leads to compartment 20 that is formed on base 12 and base divider 16. In another embodiment, compartment 20 and opening 21 are sized and shaped so that smokable or vapable items 102 (FIGS. 7 and 20) such as tobacco products (i.e., mini-cigarettes or cigars) and/or marijuana products can be placed within opening 21 and stored in compartment 20, as will be discussed in greater detail later.

A still another unique aspect of the present invention is base inset 22. In one embodiment, base inset 22 can be used in conjunction with latch 62 (FIG. 6) in order to assist in retaining lid assembly 50 onto base assembly 10, as will be discussed in greater detail later.

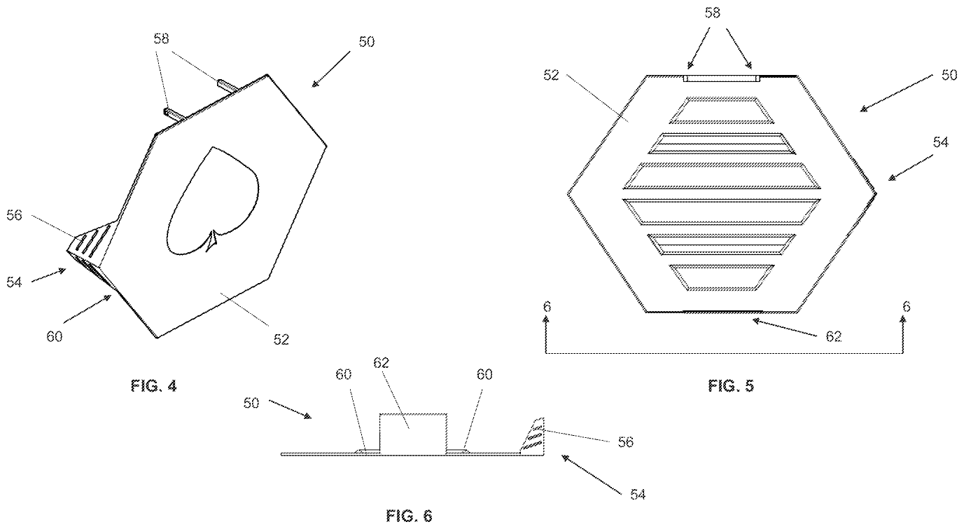

Another unique aspect of the present invention is slots 24. In one embodiment, slots 24 can be used in conjunction with lid extensions 58 (FIG. 4) so that lid assembly 50 will be able to pivot away from and towards base assembly 10, as will be discussed in greater detail later. In this manner, slots 24 and lid extensions 58 will interact with each other to create a “hinge” between the lid assembly 50 and the base assembly 10.

With respect to lid assembly 50, as shown in FIGS. 4-6, lid assembly 50 includes in part, lid 52, compartment extension 54, ridges 56, lid extensions 58, pill break ridges 60 and latch 62. In one embodiment, lid 52, compartment extension 54, ridges 56, lid extensions 58, pill break ridges 60, and latch 62 are formed onto lid 52 by conventional forming techniques such as printing, grinding, molding or the like.

There are several unique aspects of the present invention with respect to compartment extension 54 and ridges 56. In one embodiment, compartment extension 54 is located on lid 52 so that compartment extension will allow 1.) the user to easily rotate the lid assembly 50 towards and away from the base assembly 10, and 2.) provides a door or other similar closure over opening 21. As will be discussed in greater detail later, after the user has placed smokable or vapable items 102 (FIGS. 7 and 20) such as tobacco products (i.e., mini-cigarettes or cigars) and/or marijuana products in compartment 20 through opening 21, the user can simply rotate the lid assembly 50 towards base assembly 10 so that the compartment extension 54 covers over opening 21 so that the small items 102 are securely retained within compartment 20 (FIG. 20). Furthermore, compartment extension 54 is equipped with ridges 56 that will provide the user with a gripping surface that will allow the user to easily manipulate the lid assembly 50 towards or away from the base assembly 10.

Another unique aspect of the present invention is lid extensions 58. As discussed above, in one embodiment, lid extensions 58 can be used in conjunction with slots 24 in order to allow lid assembly 50 to pivot towards or away from base assembly 10.

A still another unique aspect of the present invention is pill break ridges 60. In one embodiment, pill break ridges 60 are formed on the underside of lid 52 (FIG. 6). Typically, a pill 100 can be broken by just using both hands and applying pressure to each end of the pill 100. However, in the present invention, the pill break ridges 60 are for breaking the hard pills 100 that conventionally have “splits” or other similar dividers (not shown) located on them. As will be discussed in greater detail later, the lid 52 would be opened and laid across a surface or countertop (not shown) to secure the lid 52 from moving around. The user can then apply pressure on the lid 52 near the pill break ridge 60 that is contacting the pill 100 in order to break the pill 100 in half.

### Attaching the Base Assembly to the Lid Assembly

In order to attach base assembly 10 to lid assembly 50, attention is directed to FIGS. 7-14. In particular, the lid extensions 58 on lid assembly 50 are located adjacent to the slots 24 on the base assembly 10 so that the lid extensions 58 are rotatably retained within the slots 24 (FIGS. 10, 12, and 14). In this manner, the lid assembly 50 is located in an open position with respect to base assembly 10.

After the lid assembly 50 has been rotatably connected to the base assembly 10, the desired pills 100, capsules, tablets, supplements, or other similar medications are placed in pill wells 14, as shown in FIG. 7.

### Operation of Pill Container

In order to operate pill container 2, attention is directed to FIGS. 7-20. As discussed above, after lid assembly 50 is rotatably attached to base assembly 10, the desired pills 100, capsules, tablets, supplements, or other similar medications are placed in pill wells 14, as shown in FIG. 7.

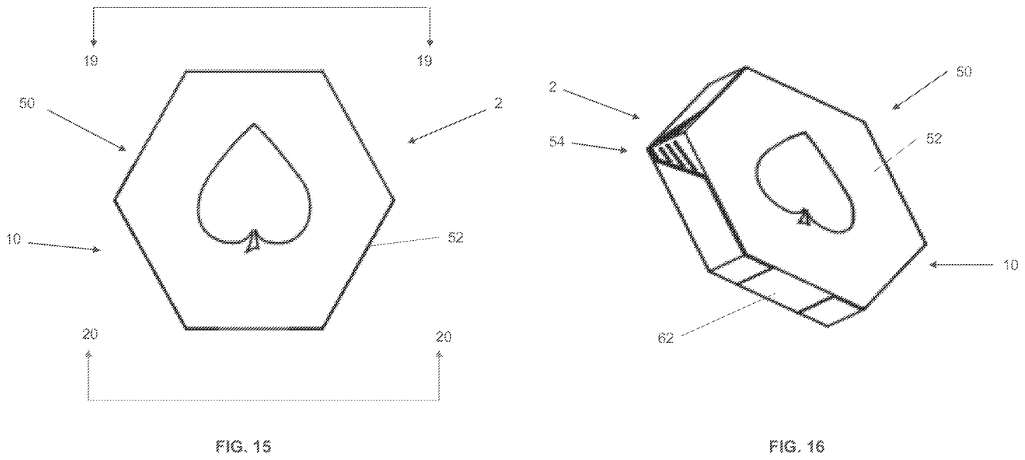

Once the desired pills 100 are placed in pill wells 14, as shown in FIGS. 15-20, lid assembly 50 is rotated towards base assembly 10 so that lid assembly 50 can be attached to base assembly 10. In one embodiment, latch 62 interacts with base insert 22 so that latch 62 is removably attached to base insert 22 (FIGS. 16, 17, and 20). In this manner, lid assembly 50 (in particular lid 52) should remain in a closed position over base assembly 10.

Another unique aspect of the present invention is the use of compartment 20, opening 21 and base divider 16. As discussed above, smokable or vapable items 102 (FIGS. 7 and 20) such as tobacco products (i.e., mini-cigarettes or cigars) and/or marijuana products can be placed within opening 21 and stored in compartment 20. Once the small items 102 are stored in compartment 20, the user can simply rotate the lid assembly 50 towards base assembly 10 so that the compartment extension 54 covers over opening 21 so that the small items 102 are securely retained within compartment 20 (FIG. 20). Furthermore, compartment extension 54 is equipped with ridges 56 that will provide the user with a gripping surface that will allow the user to easily manipulate the lid assembly 50 towards or away from the base assembly 10.

In order to open the lid assembly 50 away from the base assembly 10, the user holds onto the bottom of the base assembly 10 and places a thumb on extension 54 so that the user's thumb contacts the ridges 56. Also, the user places a finger on the latch 62 so that the latch will be removably released from the base inset 22. The user then pulls on the lid assembly 50 with one hand and holds onto the bottom of the base assembly 10 with the other hand in order to lift the lid assembly 50 away from the base assembly 10. The user can then access the desired pill 100 or the small item 102.

The preceding merely illustrates the principles of the invention. It will thus be appreciated that those skilled in the art will be able to devise various arrangements which, although not explicitly described or shown herein, embody the principles of the invention and are included within its spirit and scope. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

All patents, publications, scientific articles, web sites, and other documents and materials referenced or mentioned herein are indicative of the levels of skill of those skilled in the art to which the invention pertains, and each such referenced document and material is hereby incorporated by reference to the same extent as if it had been incorporated by reference in its entirety individually or set forth herein in its entirety. Applicants reserve the right to physically incorporate into this specification any and all materials and information from any such patents, publications, scientific articles, web sites, electronically available information, and other referenced materials or documents to the extent such incorporated materials and information are not inconsistent with the description herein.

The written description portion of this patent includes all claims. Furthermore, all claims, including all original claims as well as all claims from any and all priority documents, are hereby incorporated by reference in their entirety into the written description portion of the specification, and Applicant(s) reserve the right to physically incorporate into the written description or any other portion of the application, any and all such claims. Thus, for example, under no circumstances may the patent be interpreted as allegedly not providing a written description for a claim on the assertion that the precise wording of the claim is not set forth in haec verba in written description portion of the patent.

The claims will be interpreted according to law. However, and notwithstanding the alleged or perceived ease or difficulty of interpreting any claim or portion thereof, under no circumstances may any adjustment or amendment of a claim or any portion thereof during prosecution of the application or applications leading to this patent be interpreted as having forfeited any right to any and all equivalents thereof that do not form a part of the prior art.

All of the features disclosed in this specification may be combined in any combination. Thus, unless expressly stated otherwise, each feature disclosed is only an example of a generic series of equivalent or similar features.

It is to be understood that while the invention has been described in conjunction with the detailed description thereof, the foregoing description is intended to illustrate and not limit the scope of the invention, which is defined by the scope of the appended claims. Thus, from the foregoing, it will be appreciated that, although specific embodiments of the invention have been described herein for the purpose of illustration, various modifications may be made without deviating from the spirit and scope of the invention. Other aspects, advantages, and modifications are within the scope of the following claims and the present invention is not limited except as by the appended claims.

The specific methods and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, the terms “comprising,” “including,” “containing,” etc. are to be read expansively and without limitation. The methods and processes illustratively described herein suitably may be practiced in differing orders of steps, and that they are not necessarily restricted to the orders of steps indicated herein or in the claims.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by various embodiments and/or preferred embodiments and optional features, any and all modifications and variations of the concepts herein disclosed that may be resorted to by those skilled in the art are considered to be within the scope of this invention as defined by the appended claims.

The invention has been described broadly and generically herein. Each of the narrower species and sub-generic groupings falling within the generic disclosure also form part of the invention. This includes the generic description of the invention with a proviso or negative limitation removing any subject matter from the genus, regardless of whether or not the excised material is specifically recited herein.

Other embodiments are within the following claims. Therefore, the patent may not be interpreted to be limited to the specific examples or embodiments or methods specifically and/or expressly disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

Other modifications and implementations will occur to those skilled in the art without departing from the spirit and the scope of the invention as claimed. Accordingly, the description hereinabove is not intended to limit the invention, except as indicated in the appended claims.

Therefore, provided herein is a new and improved pill container. The preferred pill container, according to various embodiments of the present invention, offers the following advantages: ease of use; lightness in weight; durability; portability; the ability to hold a plurality of different types of pills, capsules, tablets, supplements, or other similar medications; the ability to retain other smokable or vapable items such as tobacco products like mini-cigarettes or cigars and/or marijuana products; the ability to properly retain the different types of pills, capsules, tablets, supplements, or other similar medications within the base; the ability to break hard pills, capsules, tablets, supplements, or other similar medications; and ease of opening the container. In fact, in many of the preferred embodiments, these advantages of: ease of use; lightness in weight; durability; portability; the ability to hold a plurality of different types of pills, capsules, tablets, supplements, or other similar medications; the ability to retain other smokable or vapable items such as tobacco products like mini-cigarettes or cigars and/or marijuana products; the ability to properly retain the different types of pills, capsules, tablets, supplements, or other similar medications within the base; the ability to break hard pills, capsules, tablets, supplements, or other similar medications; and ease of opening the container are optimized to an extent that is considerably higher than heretofore achieved in prior, known pill containers.

What is claimed is:

1. A pill container, comprising:
a base assembly, wherein the base assembly further comprises;
a base,
a plurality of slots located on one edge of the base,
a plurality of pill wells located around a periphery of the base, wherein each of the pill wells is sized and shaped to retain a pill,
a base divider located adjacent to the plurality of pit wells, and
a bottom located adjacent to the plurality of the pit wells and the base divider; and
a lid assembly, wherein the lid assembly further comprises;
a lid,
a plurality of lid extensions operatively connected to a first edge of the lid, wherein each of the plurality of lid extensions is rotatably retained within one of the plurality of slots,
a latch operatively connected to a second edge of the lid, and
a compartment extension operatively connected to a third and fourth edge of the lid.

2. The pill container, according to claim 1, wherein the base assembly is further comprised of:
an opening located on a corner of the base; and
a first compartment, wherein the first compartment is operatively connected to the opening and located between the base divider and the bottom, and wherein the first compartment retains an item.

3. The pill container, according to claim 1, wherein the base assembly is further comprised of:
a plurality of second compartments, wherein each of the plurality of second compartments are located adjacent to the base divider and the base.

4. The pill container, according to claim 1, wherein the base assembly is further comprised of:
a base insert located on a second edge of the base, wherein the base insert interacts with the latch in order to assist in retaining the lid assembly over the base assembly.

5. The pill container, according to claim 2, wherein the compartment extension is further comprised of:
a plurality of ridges located along one side of the compartment extension; and
the compartment extension covers the opening in order to assist in retaining the item within the first compartment.

6. The pill container, according to claim 1, wherein the lid assembly is further comprised of:
a plurality of pill break ridges located on one side of the lid.

7. A method of constructing a pill container, comprising:
providing a base assembly, wherein the base assembly further comprises;
a base,
a plurality of slots located on one edge of the base,
a plurality of pill wells located around a periphery of the base, wherein each of the pill wells is sized and shaped to retain a pill,
a base divider located adjacent to the plurality of pit wells, and
a bottom located adjacent to the plurality of the pit wells and the base divider; and
providing a lid assembly, wherein the lid assembly further comprises;
a lid,
a plurality of lid extensions operatively connected to a first edge of the lid, wherein each of the plurality of lid extensions is rotatably retained within one of the plurality of slots,
a latch operatively connected to a second edge of the lid, and
a compartment extension operatively connected to a third and fourth edge of the lid.

8. The method, according to claim 7, wherein the providing the base assembly further comprises:
providing an opening located on a corner of the base; and
providing a first compartment, wherein the first compartment is operatively connected to the opening and located between the base divider and the bottom, and wherein the first compartment retains an item.

9. The method, according to claim 7, wherein the providing the base assembly further comprises:
providing a plurality of second compartments, wherein each of the plurality of second compartments are located adjacent to the base divider and the base.

10. The method, according to claim 7, wherein the providing the base assembly further comprises:
providing a base insert on a second edge of the base, wherein the base insert interacts with the latch in order to assist in retaining the lid assembly over the base assembly.

11. The method, according to claim 8, wherein the compartment extension is further comprised of:
a plurality of ridges located along one side of the compartment extension; and
the compartment extension covers the opening in order to assist in retaining the item within the first compartment.

12. The method, according to claim 7, wherein the providing the lid assembly further comprises:
providing a plurality of pill break ridges on one side of the lid.

13. A method of using a pill container, comprising:
providing a base assembly, wherein the base assembly further comprises;
a base,
a plurality of slots located on one edge of the base,
a plurality of pill wells located around a periphery of the base, wherein each of the pill wells is sized and shaped to retain a pill,
a base divider located adjacent to the plurality of pit wells, and
a bottom located adjacent to the plurality of the pit wells and the base divider;
providing a lid assembly, wherein the lid assembly further comprises;
a lid,
a plurality of lid extensions operatively connected to a first edge of the lid, wherein each of the plurality of lid extensions is rotatably retained within one of the plurality of slots,
a latch operatively connected to a second edge of the lid, and
a compartment extension operatively connected to a third and fourth edge of the lid;
placing at least one pill within at least one of the plurality of pill wells; and
rotating the lid towards the base such that the latch interacts with the base in order to secure the lid to the base assembly.

14. The method, according to claim 13, wherein the providing the base assembly further comprises:
providing an opening located on a corner of the base;
providing a first compartment, wherein the first compartment is operatively connected to the opening and located between the base divider and the bottom, and wherein the first compartment retains an item; and
placing the item through the opening and into the first compartment such that the item is located within the first compartment.

15. The method, according to claim 13, wherein the providing the base assembly further comprises:
providing a plurality of second compartments, wherein each of the plurality of second compartments are located adjacent to the base divider and the base.

16. The method, according to claim 13, wherein the providing the base assembly further comprises:
providing a base insert on a second edge of the base, wherein the base insert interacts with the latch in order to assist in retaining the lid assembly over the base assembly.

17. The method, according to claim 14, wherein the compartment extension is further comprised of:
a plurality of ridges located along one side of the compartment extension; and
the compartment extension covers the opening in order to assist in retaining the item within the first compartment.

18. The method, according to claim 13, wherein the providing the lid assembly further comprises:
providing a plurality of pill break ridges on one side of the lid so that at least one of the pill break ridges can be used to break a pill.
